(19) United States
(12) Patent Application Publication
(10) Pub. No.: US 2011/0285668 A1
(43) Pub. Date: Nov. 24, 2011

(54) TOUCH INPUT DEVICE

(75) Inventors: Jun Seok KIM, Yongin-si (KR); Tae Youn KWON, Suwon-si (KR); Jong Sam PARK, Yongin-si (KR)

(73) Assignee: SAMSUNG ELECTRONICS CO. LTD., Suwon-si (KR)

(21) Appl. No.: 13/110,315

(22) Filed: May 18, 2011

(30) Foreign Application Priority Data
May 24, 2010 (KR) 10-2010-0048072

(51) Int. Cl. G06F 3/044; G06F 3/041

(52) U.S. Cl. 345/174; 345/173

(57) ABSTRACT

A touch input device is provided. The touch input device includes, a Printed Circuit Board (PCB), a plurality of Light Emitting Diodes (LEDs) mounted on the PCB and electrically connected to the PCB, a holder installed on the PCB and placed around the LEDs, and a touch sensor, placed on the LEDs and the holder, for transmitting light.

### PRIORITY

This application claims the benefit under 35 U.S.C. §119(a) of a Korean patent application filed on May 24, 2010 in the Korean Intellectual Property Office and assigned Serial No. 10-2010-0048072, the entire disclosure of which is hereby incorporated by reference.

### BACKGROUND OF THE INVENTION

1. Field of the Invention

The present invention relates to a touch input device. More particularly, the present invention relates to a touch input device that can enhance convenience for the user entering touches in a touch-based mobile terminal.

2. Description of the Related Art

A touch input device detects a touch entered by the user and generates a corresponding electrical signal. In recent years, touch input devices have been used in various types of mobile terminals including cellular phones. Touch input devices recently used have included a Liquid Crystal Display (LCD) technology to provide a display apparatus for a user. However, the LCD technology has limitations regarding its usability with a touch-based mobile terminal. Accordingly, there is a need for an improved apparatus for use with a touch input device of a mobile terminal.

### SUMMARY OF THE INVENTION

An aspect of the present invention is to address at least the above-mentioned problems and/or disadvantages and to provide at least the advantages described below. Accordingly, an aspect of the present invention is to provide a touch input device that can enhance usability of a touch-based mobile terminal.

In accordance with an aspect of the present invention, a touch input device is provided. The device includes a Printed Circuit Board (PCB), a plurality of Light Emitting Diodes (LEDs) mounted on the PCB and electrically connected to the PCB, a holder installed on the PCB and placed around the LEDs, and a touch sensor, placed on the LEDs and the holder, for transmitting light.

The touch sensor may detect a change in capacitance when a touch gesture is made. The touch sensor may be arranged so as to be parallel with the PCB. The touch sensor may be electrically connected to the PCB.

The LEDs may be turned on and off or changed in brightness or color according to a capacitance change detected by the touch sensor.

The touch input device may further include a shielding sheet on the touch sensor, and the shielding sheet may have a plurality of holes for transmitting light emitted by the LEDs. The shielding sheet may decrease intensity of light emitted by the LEDs. The touch sensor may be placed so that one surface thereof faces the shielding sheet and the other surface faces the holder. The holes of the shielding sheet may have a size smaller than that of holes of the holder. The holder may subdivide the LEDs into several groups. The holder may have multiple holes corresponding to the LEDs and the LEDs may be inserted in the corresponding holes. The LEDs may have a height less than that of the holes of the holder. The touch sensor may have a semi-transparent electrode and a metal electrode, which are electrically connected.

In accordance with another aspect of the present invention, a touch input device is provided. The device includes a PCB, a plurality of LEDs mounted on the PCB and electrically connected to the PCB, a holder installed on the PCB and having a plurality of holes corresponding to the LEDs, and a touch sensor, placed on the LEDs and the holder, for transmitting light.

In an exemplary implementation of the present invention, the touch input device enables the user to enter a touch gesture in a convenient way.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a view of a touch input device according to an exemplary embodiment of the present invention;

FIG. 2 is a sectional view of the touch input device of FIG. 1 according to an exemplary embodiment of the present invention;

FIG. 3 is an exploded view of the touch input device of FIG. 1 according to an exemplary embodiment of the present invention;

FIG. 4 illustrates installation of the touch input device of FIG. 1 in a mobile terminal according to an exemplary embodiment of the present invention; and

FIG. 5 illustrates manipulation of the touch input device of FIG. 1 according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

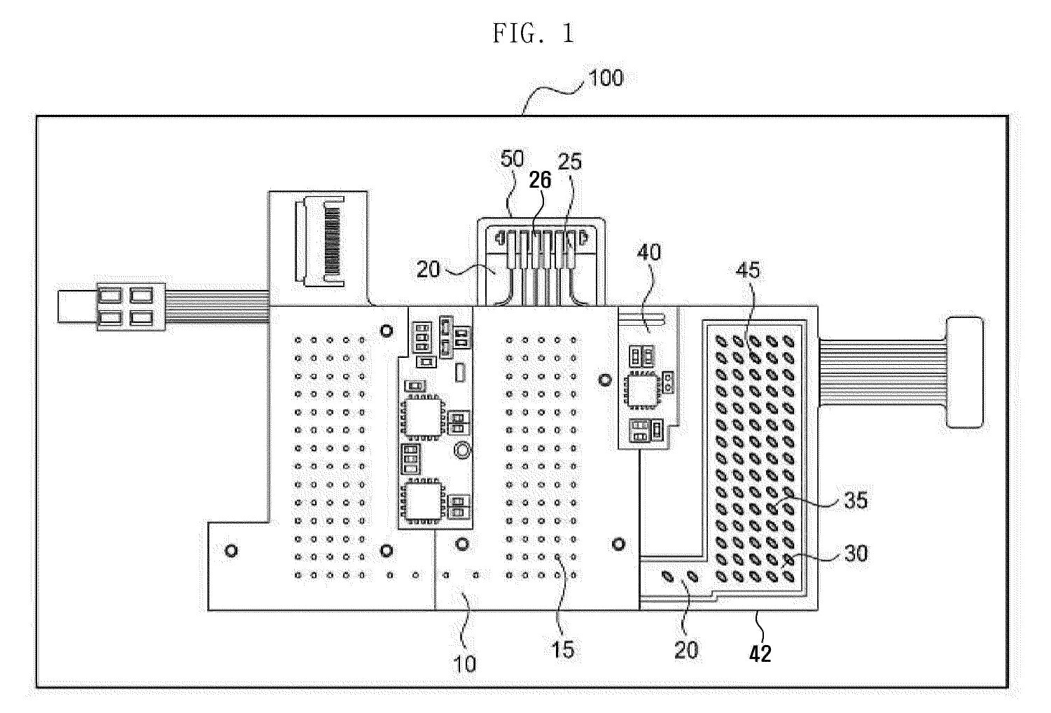

FIG. 1 is a view of a touch input device according to an exemplary embodiment of the present invention.

Referring to FIG. 1, the touch input device 100 may include a Printed Circuit Board (PCB) 40, a plurality of Light Emitting Diodes (LEDs) 45 mounted on the PCB 40 and electrically connected to the PCB 40, a holder 30 placed around the LEDs 45, and a touch sensor 20, mounted on the LEDs 45 and the holder 30, for transmitting light. Multiple LEDs 45 are mounted on the PCB 40. The LEDs 45 are arranged in a tilted fashion so as to form a given angle with a side edge 42 of the PCB 40. For example, the LEDs 45 may be arranged so as to form an angle of 45 degrees with the side edge 42 of the PCB 40. When the LEDs 45 are arranged so as to form an angle of 45 degrees with the side edge 42 of the PCB 40, it becomes easier to align the LEDs 45 with a shielding sheet 10 described later. As the LEDs 45 are arranged in a matrix form and each LED 45 can be made to emit light separately, selected LEDs 45 at specified sites may be caused to emit light so as to generate a preset shape or image. Color or brightness may also be adjusted by regulating voltage applied to the LEDs 45. The LEDs 45 can be soldered to patterns printed in the PCB 40 and electrically connected to the PCB 40.

The holder 30 may be placed around the LEDs 45. The holder 30 may be placed around the LEDs 45 so as to surround the LEDs 45. That is, the holder 30 may enclose the LEDs 45. The holder 30 prevents light emitted by the LEDs 45 from traveling in a direction parallel with the surface of the PCB 40. More specifically, the holder 30 includes a plurality of holes 35, each of which has a height, length and width greater than that of the LED 45. The holes 35 of the holder 30 may correspond respectively to the LEDs 45. The holder 30 may be realized as a single entity or multiple entities. For example, the holder 30 may be composed of a single sheet having multiple holes 35 accommodating the LEDs 45. Each of the holes 35 has a shape similar to the LED 45 and has a height, length and width greater than that of the LED 45. When the holder 30 is installed on the PCB 40, the LEDs 45 are inserted in the corresponding holes 35. Since each of the holes 35 has a height greater than that of each of the LEDs 45, the light emitted by the LEDs 45 cannot travel in a direction parallel with the PCB 40 but can travel in a direction perpendicular thereto. The touch sensor 20 is placed on the LEDs 45 and the holder 30 and transmits light. The touch sensor 20 may be made of a transparent film for transmitting light. The touch sensor 20 may be implemented using resistive, capacitive, Surface Acoustic Wave (SAW), or infrared technology. Resistive and capacitive touch sensors are most widely used. In a resistive touch sensor, in which two substrates are respectively coated with transparent electrodes and layered together, when the user applies pressure with a finger or pen to thereby bring the upper electrode into contact with the lower electrode, an electrical signal indicating the touched location is generated. A capacitive touch sensor detects static electricity generated by a human body. Typically, a capacitive touch sensor is durable, has a fast response time, and has good transmittance.

In an exemplary embodiment, the touch sensor 20 may be a capacitive touch sensor, which detects a change in capacitance when a touch gesture is made. In another exemplary embodiment, the touch sensor 20 may be a resistive touch sensor, which detects an electrical signal indicating the touched location.

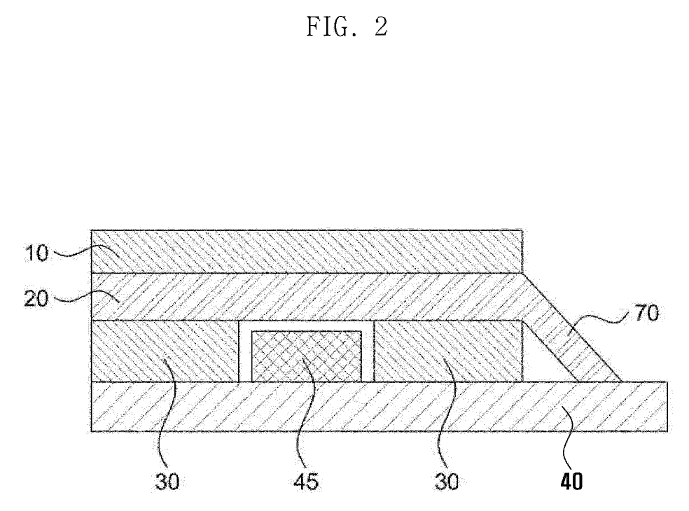

FIG. 2 is a sectional view of the touch input device of FIG. 1 according to an exemplary embodiment of the present invention.

Referring to FIG. 2, the LED 45 and the holder 30 are installed on the PCB 40. In an exemplary implementation, the LED 45 is soldered to the PCB 40 and electrically connected to the PCB 40. The holder 30 is placed around the LED 45. The holder 30 has a height greater than that of the LED 45. For example, the height of the holder 30 is 0.4 mm and the height of the LED 45 is 0.2 mm. As the holder 30 has a greater height than the LED 45, light emitted by the LED 45 cannot travel in a direction parallel with the surface of the PCB 40. That is, the holder 30 prevents light emitted by the LEDs 45 from traveling in a direction parallel with the surface of the PCB 40. A double-sided tape (not shown) is present between the holder 30 and the PCB 40. The double-sided tape has a thickness of 0.05 mm, and fixes the holder 30 to the PCB 40.

The touch sensor 20 is placed on the holder 30. A double-sided tape (not shown) is present between the holder 30 and the touch sensor 20. At an edge of the holder 30, the touch sensor 20 has a sloped or beveled edge 70. The touch sensor 20 is made of a transparent film, which has a transparent electrode coated with a transparent conductive material such as Indium Tin Oxide (ITO). Instead of the transparent electrode, a semi-transparent electrode transmitting some light may be used according to a selected manufacturing process. A metal electrode is present outside the transparent film. When the transparent electrode is touched, a change in capacitance is generated. The touch sensor 20 is placed so as to be parallel with the PCB 40. Light emitted by the LED 45 may pass through the touch sensor 20 made of a transparent film. The touch sensor 20 may be electrically connected to the PCB 40. For example, the touch sensor 20 may be electrically connected to the PCB 40 through hot-bar reflow or through a connector (not shown). As the touch sensor 20 is electrically connected to the PCB 40, when a touch is detected, the touch sensor 20 generates an electrical signal corresponding to change in capacitance and sends the electrical signal to a controller (not shown). Upon reception of the electrical signal, the controller may turn the LED 45 on or off, adjust brightness of the LED 45, or change color of the LED 45.

A shielding sheet 10 is placed on the touch sensor 20. The shielding sheet 10 may reduce intensity of light emitted by the LED 45. The shielding sheet 10 has a hole (not shown) to permit light emitted by the LED 45 to pass therethrough. The hole is smaller than the LED 45. Because the hole of the shielding sheet 10 is smaller than the LED 45, only some of the light emitted by the LED 45 may pass through the hole. The brightness of light passing through the hole of the shielding sheet 10 varies depending upon the thickness of the shielding sheet 10. That is, when the shielding sheet 10 is thick, the brightness is low, and when the shielding sheet 10 is thin, the brightness is high. For example, it may be assumed that the brightness of light passing through the hole corresponds to a value of 100 when the shielding sheet 10 has a thickness of 0.35 mm. Then, the brightness of light passing through the hole may correspond to a value of 80 when the shielding sheet 10 has a thickness of 0.55 mm, and the brightness of light may correspond to a value of 60 when the shielding sheet 10 has a thickness of 0.75 mm. As described above, the brightness of the light may be regulated by adjusting the thickness of the shielding sheet 10. In an exemplary embodiment, the brightness of the light may be adjusted by using shielding sheets having different thicknesses.

The shielding sheet 10, the touch sensor 20, the holder 30 and the PCB 40 are bonded together through adhesives such as double-sided tapes, and may be utilized as a single component. Here, the touch sensor 20 is placed between the shielding sheet 10 and the holder 30. That is, one surface of the touch sensor 20 faces the shielding sheet 10 and the other surface thereof faces the holder 30. In an exemplary embodiment, the touch sensor 20 has a thickness of 0.076 mm, the shielding sheet 10 has a thickness of 0.35 mm to 0.75 mm, and the holder 30 has a thickness of 0.4 mm. As the touch sensor 20 is thinner than the shielding sheet 10 and the holder 30, the touch sensor 20 may be placed between the shielding sheet 10 and the holder 30 for easy assembly.

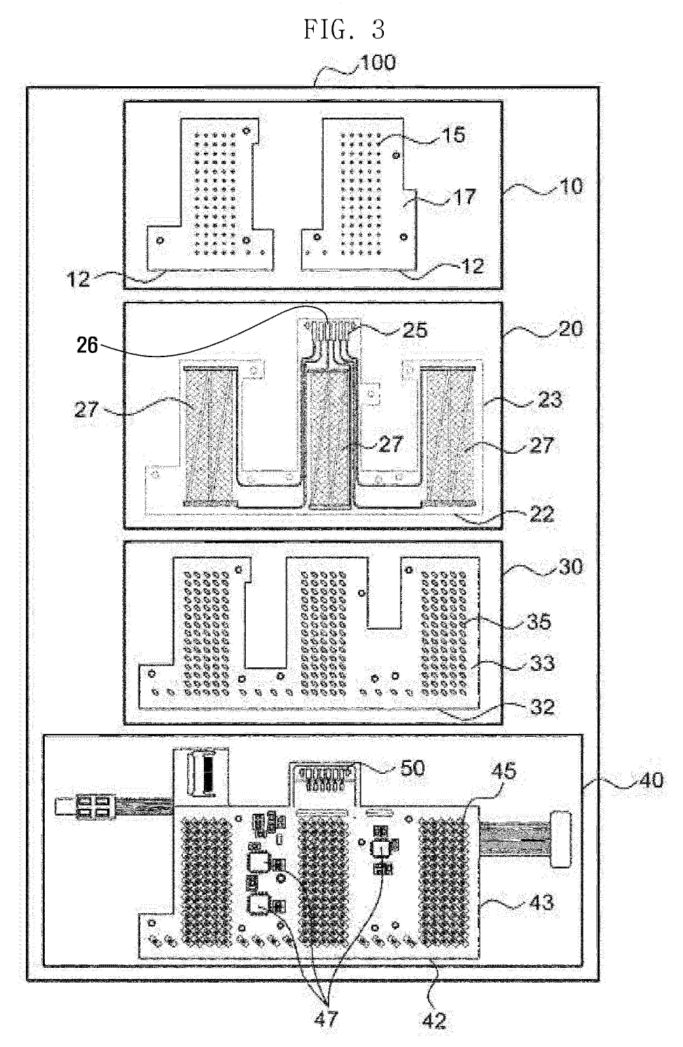

FIG. 3 is an exploded view of the touch input device of FIG. 1 according to an exemplary embodiment of the present invention.

Referring to FIG. 3, the touch input device 100 includes a PCB 40 on which a plurality of LEDs 45 are mounted, a holder 30 installed on the PCB 40 and placed around the LEDs 45, a touch sensor 20 mounted on the LEDs 45 and the holder 30 and transmitting light, and a shielding sheet 10 placed on the touch sensor 20.

The LEDs 45 may be arranged in a matrix form. When the holder 30 and the shielding sheet 10 are mounted on the PCB 40, the centers of the LEDs 45 must be aligned respectively with the centers of holes 15 of the shielding sheet 10. To achieve this, the LEDs 45 are arranged so as to form a given angle with respect to a side edge 42 of the PCB 40. For example, the LEDs 45 may be arranged so as to form an angle of 45 degrees with respect to the side edge 42 of the PCB 40. When the LEDs 45 are arranged so as to form an angle of 45 degrees with respect to the side edge 42 of the PCB 40, it becomes easy to align the LEDs 45 with the shielding sheet 10.

The LEDs 45 and other circuit elements 47 are soldered to the PCB 40. The PCB 40 contains patterns to electrically connect the LEDs 45 to the circuit elements 47. The PCB 40 includes a hot-bar pad 50 to electrically connect the touch sensor 20 to the PCB 40.

The holder 30 is installed on the PCB 40. The holder 30 includes a plurality of holes 35 having a shape similar to the LED 45. The holes 35 have a size and a height greater than that of the LED 45. That is, the LED 45 has a height less than that of the hole 35. When the holder 30 is installed on the PCB 40, the LEDs 45 are inserted in the corresponding holes 35. The holder 30 subdivides the LEDs 45 into several groups. Side edges 32 and 33 of the holder 30 are aligned with side edges 42 and 43 of the PCB 40. That is, when the holder 30 is installed on the PCB 40, the LEDs 45 on the PCB 40 are inserted in the corresponding holes 35 of the holder 30. Hence, for easy assembly, the side edges 32 and 33 of the holder 30 are aligned with the side edges 42 and 43 of the PCB 40. As described above, the holder 30 takes the form of a sheet having multiple holes 35 corresponding to the LEDs 45, and the LEDs 45 can be inserted in the corresponding holes 35. The touch sensor 20 includes a semi-transparent electrode region 27 made of a transparent film coated with ITO, and first and second metal electrodes 26 and 25 electrically connecting the semi-transparent electrode region 27 to the PCB 40. The semi-transparent electrode region 27 may decrease intensity of light emitted by the LEDs 45. The shielding sheet 10 may also decrease intensity of light emitted by the LEDs 45. The second metal electrode 25 may be electrically connected to the PCB 40 through hot-bar reflow. The second metal electrode 25 may also be electrically connected to the PCB 40 through a connector (not shown). Side edges 22 and 23 of the touch sensor 20 may be aligned with the side edges 32 and 33 of the holder 30. The touch sensor 20 is placed between the holder 30 and the shielding sheet 10, and may be bonded with the holder 30 and the shielding sheet 10 through adhesives such as double-sided tapes.

The shielding sheet 10 is composed of a blocking region 17 blocking light emitted by the LEDs 45 and holes 15 transmitting light. The holes 15 have a size less than that of the LEDs 45. Hence, for a given hole 15, light emitted by an LED 45 directly below the hole 15 may pass through the hole 15, and light emitted by the other LEDs 45 is blocked by the blocking region 17. The holes 15 of the shielding sheet 10 have a size less than that of the holes 35 of the holder 30. The side edge 12 of the shielding sheet 10 may be aligned with the side edge 22 of the touch sensor 20, the side edge 32 of the holder 30 and the side edge 42 of the PCB 40. The centers of the holes 15 of the shielding sheet 10, the centers of the holes 35 of the holder 30 and the centers of the LEDs 45 may coincide, respectively.

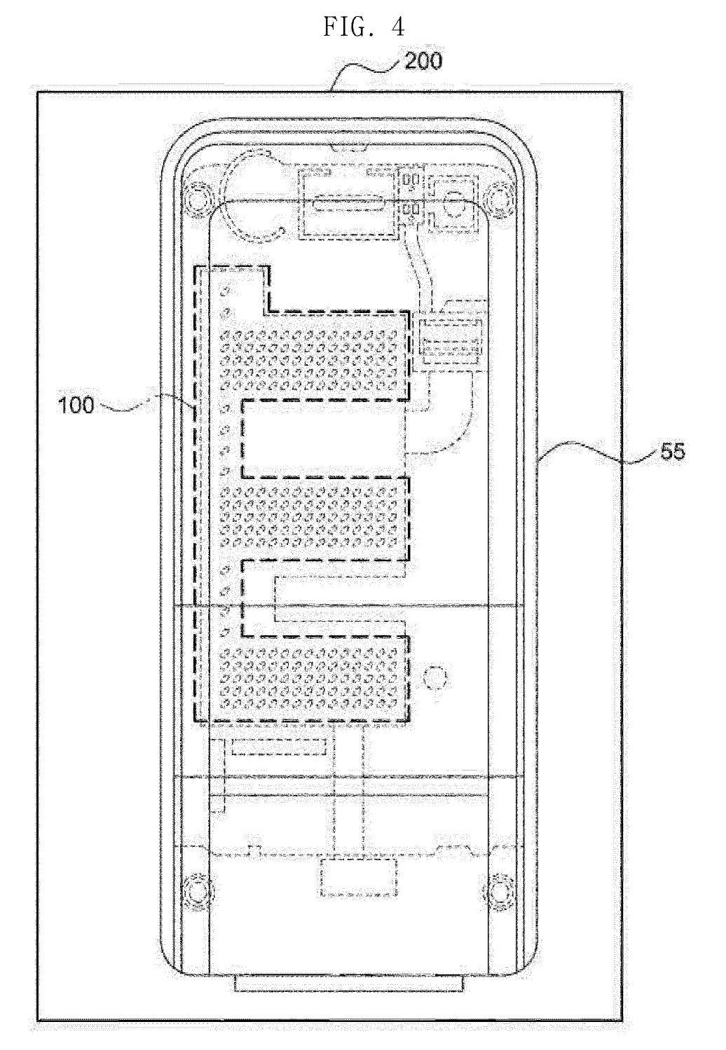

FIG. 4 illustrates installation of the touch input device of FIG. 1 in a mobile terminal according to an exemplary embodiment of the present invention.

Referring to FIG. 4, the touch input device 100 may be installed in a mobile terminal 200. As described before, the touch input device 100 may be composed of a PCB, multiple LEDs mounted on the PCB and electrically connected to the PCB, a holder placed on the PCB and having holes corresponding to the LEDs, and a touch sensor mounted on the LEDs and the holder and transmitting light. The touch input device 100 may be placed below a case 55 of the mobile terminal 200. Light emitted by the LEDs of the touch input device 100 may pass through the case 55 to form various images.

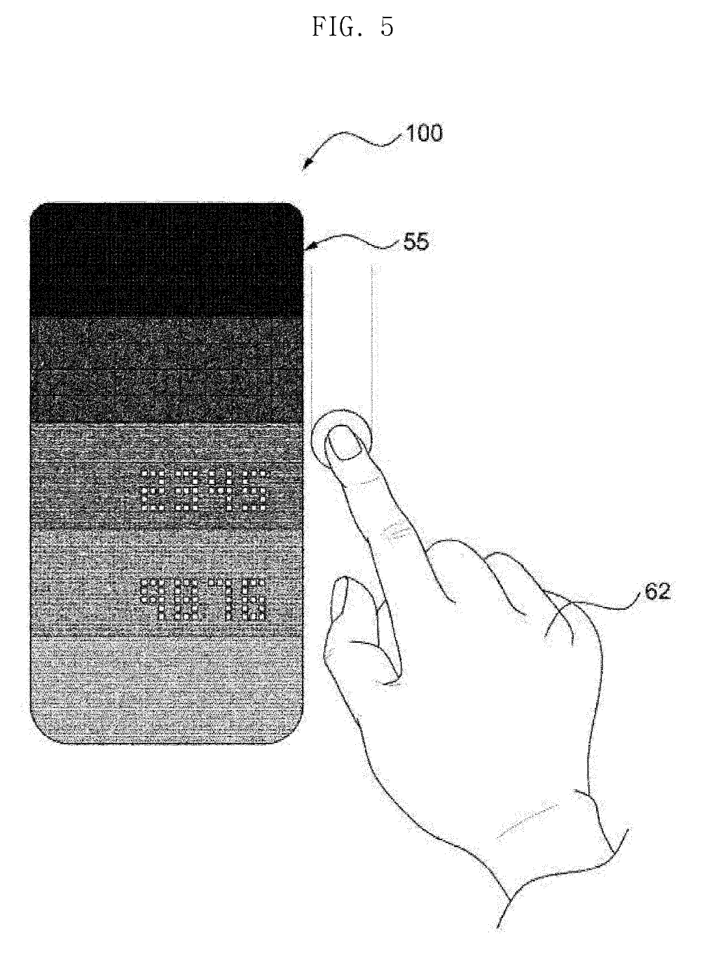

FIG. 5 illustrates manipulation of the touch input device of FIG. 1 according to an exemplary embodiment of the present invention.

Referring to FIG. 5, various images may be formed on the case 55 of the mobile terminal 200 by the LEDs of the touch input device 100. When the user touches the case 55 with a finger 62, various images may appear on the case 55 according to touch actions.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A touch input device comprising:
a Printed Circuit Board (PCB);
a plurality of Light Emitting Diodes (LEDs) mounted on the PCB and electrically connected to the PCB;
a holder installed on the PCB and placed around the LEDs; and
a touch sensor, placed on the LEDs and the holder, for transmitting light.

2. The touch input device of claim 1, wherein the touch sensor detects a change in capacitance when a touch gesture is made.

3. The touch input device of claim 1, wherein the touch sensor is arranged so as to be parallel with the PCB.

4. The touch input device of claim 1, wherein the touch sensor is electrically connected to the PCB.

5. The touch input device of claim 2, wherein the LEDs are at least one of turned on and off, changed in brightness, and changed in color according to a capacitance change detected by the touch sensor.

6. The touch input device of claim 1, further comprising a shielding sheet on the touch sensor, wherein the shielding sheet comprises a plurality of holes for transmitting light emitted by the LEDs.

7. The touch input device of claim 6, wherein the shielding sheet decreases an intensity of light emitted by the LEDs.

8. The touch input device of claim 6, wherein one surface of the touch sensor faces the shielding sheet and another surface thereof faces the holder.

9. The touch input device of claim 6, wherein the holes of the shielding sheet have a size less than that of holes of the holder.

10. The touch input device of claim 1, wherein the holder subdivides the LEDs into several groups.

11. The touch input device of claim 1, wherein the holder has multiple holes corresponding to the LEDs and the LEDs are inserted in the corresponding holes.

12. The touch input device of claim 11, wherein the LEDs have a height less than that of the holes of the holder.

13. The touch input device of claim 1, wherein the touch sensor has a semi-transparent electrode and a metal electrode, and wherein the semi-transparent electrode is electrically connected to the metal electrode.

14. The touch input device of claim 1, wherein the LEDs are mounted at an angle with respect to a side edge of the PCB.

15. The touch input device of claim 14, wherein the angle comprises a 45 degree angle.

16. A touch input device comprising:
a Printed Circuit Board (PCB);
a plurality of Light Emitting Diodes (LEDs) mounted on the PCB and electrically connected to the PCB;
a holder installed on the PCB and having a plurality of holes corresponding to the LEDs; and
a touch sensor, placed on the LEDs and the holder, for transmitting light.
